(19) United States
(12) Patent Application Publication
(10) Pub. No.: US 2025/0391059 A1
(43) Pub. Date: Dec. 25, 2025

(54) COMPOSITION FOR LAYER ROI PROCESSING

(71) Applicant: QUALCOMM Incorporated, San Diego, CA (US)

(72) Inventors: Yongjun XU, Beijing (CN); Nan ZHANG, Beijing (CN)

(21) Appl. No.: 18/880,252

(22) PCT Filed: Aug. 30, 2022
(86) PCT No.: PCT/CN2022/115725

§ 371 Date: Dec. 30, 2024

(51) Int. Cl. G06T 11/00; G06T 1/20

(52) U.S. Cl. CPC G06T 11/00; G06T 1/20

(57) ABSTRACT

Aspects presented herein relate to methods and devices for display processing including an apparatus, e.g., a DPU. The apparatus may obtain a plurality of layers associated with at least one frame, wherein each layer of the plurality of layers includes a set of layer regions, where each of the set of layer regions includes a plurality of pixels. The apparatus may also assign each of the set of layer regions to a corresponding component in a set of components in a DPU pipeline. Further, the apparatus may adjust a portion of the plurality of pixels in at least one layer region of the set of layer regions with the corresponding component in the set of components in the DPU pipeline. The apparatus may also compose the set of layer regions including the at least one layer region with the adjusted portion of the plurality of pixels.

### TECHNICAL FIELD

The present disclosure relates generally to processing systems and, more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a display processing unit (DPU), a graphics processing unit (GPU), a central processing unit (CPU), or any apparatus that may perform display processing. The apparatus may obtain a plurality of layers associated with at least one frame, where each layer of the plurality of layers includes a set of layer regions, where each of the set of layer regions includes a plurality of pixels. The apparatus may also assign each of the set of layer regions to a corresponding component in a set of components in a display processing unit (DPU) pipeline. Additionally, the apparatus may adjust a portion of the plurality of pixels in at least one layer region of the set of layer regions with the corresponding component in the set of components in the DPU pipeline. The apparatus may also compose the set of layer regions including the at least one layer region with the adjusted portion of the plurality of pixels. Moreover, the apparatus may process an output of the composition of the set of layer regions after the set of layer regions is composed, where the composition of the set of layer regions results in the output of the composition of the set of layer regions. The apparatus may also transmit the processed output of the composition of the set of layer regions.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 illustrates an example graphics processing unit (GPU).

FIG. 3 illustrates an example display framework including a display processor and a display.

FIG. 4 is a diagram illustrating an example mask layer for display processing.

FIG. 5 is a diagram illustrating an example layer composition scheme for display processing.

FIG. 6 is a diagram illustrating an example layer for display processing.

FIG. 7 is a diagram illustrating an example layer for display processing.

FIG. 8 is a diagram illustrating example display processing unit (DPU) hardware for display processing.

FIG. 9 is a diagram illustrating an example layer composition scheme for display processing.

FIG. 10 is a communication flow diagram illustrating example communications between a DPU, a GPU, and a display.

FIG. 11 is a flowchart of an example method of display processing.

FIG. 12 is a flowchart of an example method of display processing.

### DETAILED DESCRIPTION

Some types of display processing devices (e.g., mobile devices, computers, TVs, or other consumer devices) may utilize complex multiple content layouts in a single display processing layer. That is, for graphics or display stacks in operating systems of the devices, there may be a single display processing layer (i.e., display layer or layer that is associated with display processing). For instance, there may be at least one display layer that may be associated with a screen or frame for a display processing device, such that the display panel at the device may be divided amongst the display layers. Additionally, for content or end users, there may be multiple content entities in the display processing layer. This may be due to operating system limitations and/or application rendering/resource management limitations. Using a single display processing layer may provide an application with an improved performance and/or flexibility. Further, some types of applications may choose to render in using a single display processing layer. Additionally, it may be beneficial to provide a color processing capability on a per-region basis (i.e., for each region of interest (ROI) in a layer). Color processing capability on a per-region basis may be utilized with certain types of display processing unit (DPU) architecture. Moreover, it may be beneficial for devices to provide color processing at multiple sub-layer levels (i.e., for different ROIs in a layer) within a single display processing layer. In some instances, certain aspects of a DPU (e.g., DPU hardware) may process layers and/or utilize layers as a basic processing unit in a display processing operation. That is, DPU hardware may provide support for image processing or color processing on a per-layer basis. However, some types of DPU hardware may not support image processing or color processing for multiple sub-layer ROIs. For example, DPU hardware may provide image processing for a per-layer granularity, but may not be able to provide support for multiple sub-layer ROIs for image processing or color processing. Aspects of the present disclosure may provide the capability to perform image or color processing on a per-region basis within a display layer. That is, aspects presented herein may support image or color processing for each region of interest (ROI) in a single display layer. For instance, aspects of the present disclosure may support image or color processing at multiple sub-layer levels (i.e., for different ROIs in a layer) within a single display layer. For example, aspects of the present disclosure may provide support in DPU hardware to allow for image/color processing for multiple sub-layer ROIs within a single display layer. Additionally, in some instances, aspects of the present disclosure may provide a solution to single layer image processing specifications for certain types of applications. For instance, a single display processing layer may provide an application with an improved performance and/or flexibility. As such, aspects presented herein may provide a solution for advanced display processing conditions, as well as help to improve performance and/or flexibility in display processing.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

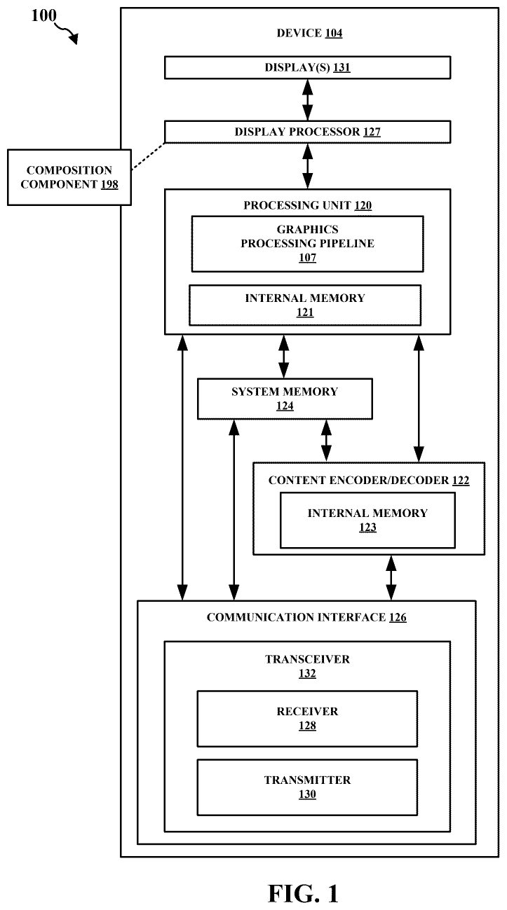

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a composition component 198 configured to obtain a plurality of layers associated with at least one frame, where each layer of the plurality of layers includes a set of layer regions, where each of the set of layer regions includes a plurality of pixels. The composition component 198 may also be configured to assign each of the set of layer regions to a corresponding component in a set of components in a display processing unit (DPU) pipeline. The composition component 198 may also be configured to adjust a portion of the plurality of pixels in at least one layer region of the set of layer regions with the corresponding component in the set of components in the DPU pipeline. The composition component 198 may also be configured to compose the set of layer regions including the at least one layer region with the adjusted portion of the plurality of pixels. The composition component 198 may also be configured to process an output of the composition of the set of layer regions after the set of layer regions is composed, where the composition of the set of layer regions results in the output of the composition of the set of layer regions. The composition component 198 may also be configured to transmit the processed output of the composition of the set of layer regions. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

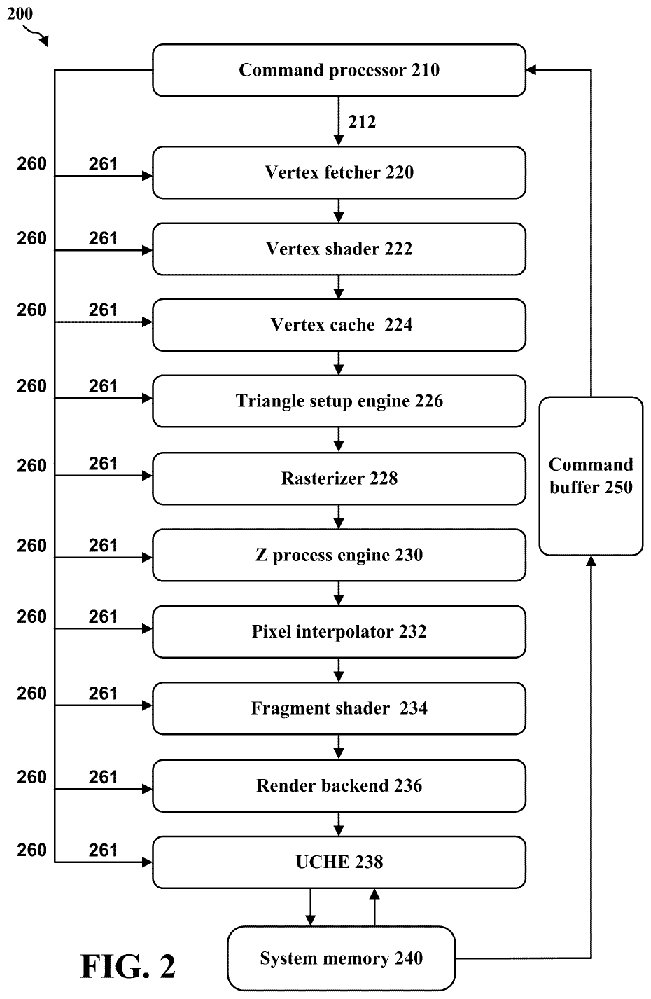

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUS according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

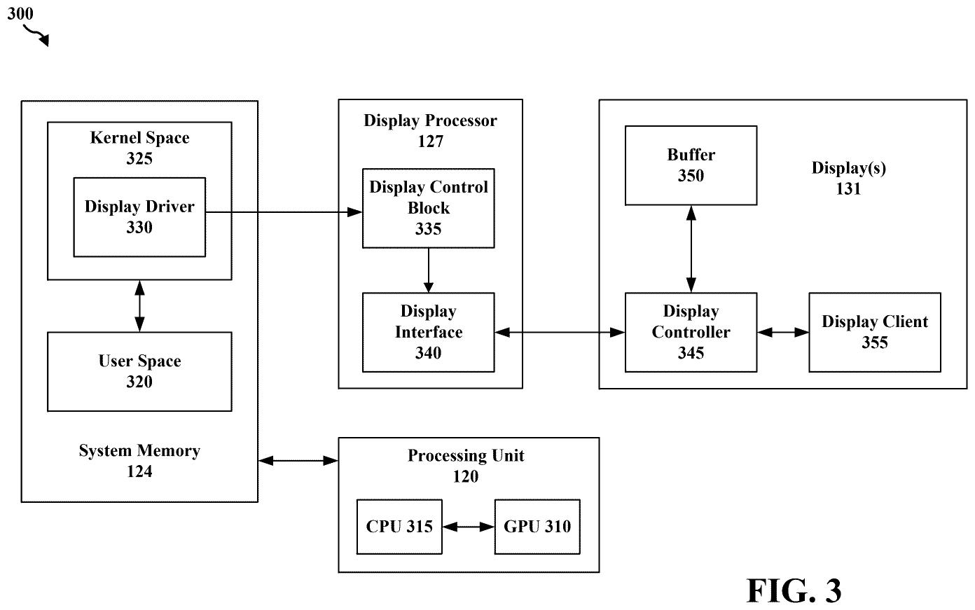

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

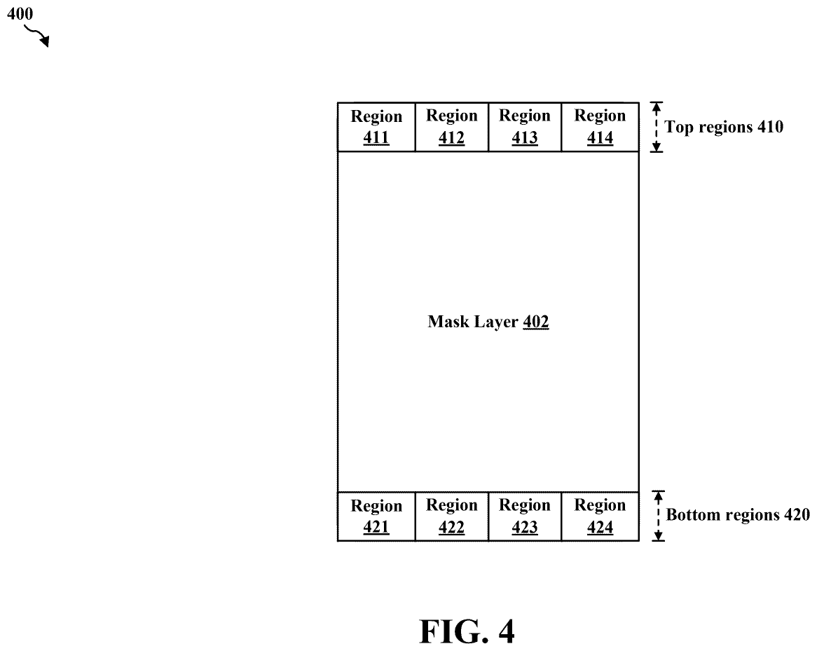

FIG. 4 is a diagram 400 illustrating an example mask layer for display processing. More specifically, diagram 400 depicts one type of mask layer that may represent portions of a display panel. As shown in FIG. 4, diagram 400 includes mask layer 402 including top regions 410 and bottom regions 420. Top regions 410 include region 411, region 412, region 413, and region 414, and bottom regions 420 include region 421, region 422, region 423, and region 424. As depicted in FIG. 4, mask layer 402 may represent the different regions that are displayed on a display panel.

Some types of displays may use a certain type of mask layer (e.g., a shape mask layer) to reshape a display frame. For instance, a mask layer may reshape the display frame to provide more optimized visual shapes at the display panel (e.g., improved round corners, improved circular shape, improved rectangular shape, etc.). These types of mask layers (e.g., shape mask layers) may be processed by software (e.g., graphics processing unit (GPU) software or central processing unit (CPU) software) or by hardware (e.g., display processing unit (DPU) hardware). Also, these mask layers may be processed by other specific types of hardware logic modules (e.g., modules in a display driver integrated circuit (DDIC) or bridge chips). In some aspects, these types of mask layers (e.g., shape mask layers) may be based on certain unit, such as a pixel. That is, the shape generation basis unit of the shape mask layers may be a single pixel.

Some aspects of display processing may utilize frame buffers to cache or store a composition output of a GPU. For instance, display layers may be cached or stored in a frame buffer after composition at a GPU. In some aspects, a composition hardware (HW) or software (SW) stack may use a frame buffer target to cache a composition output (e.g., a GPU composition output or a CPU composition output). The cached composition output may then be sent to another processor (e.g., a DPU) as an input layer. The frame buffer may have a number of different color formats, such as a red (R) green (G) blue (B) alpha (A) (RGBA) format (e.g., RGBA8888 format). Also, the frame buffer may be a certain size, (e.g., a 32-bit triple buffer). For example, at the beginning of a display/graphics subsystem design, a frame buffer may be created as an RGBA8888 format and a 32-bit triple buffer. In some instances, if the frame layers do not use a certain composition (e.g., a GPU or client composition), the frame buffers may be ignored. Also, the layers (e.g., frame layers or display layers associated with display processing) may be directly fetched and composed. For instance, a DPU or hardware composer may directly fetch the layers and then compose the layers.

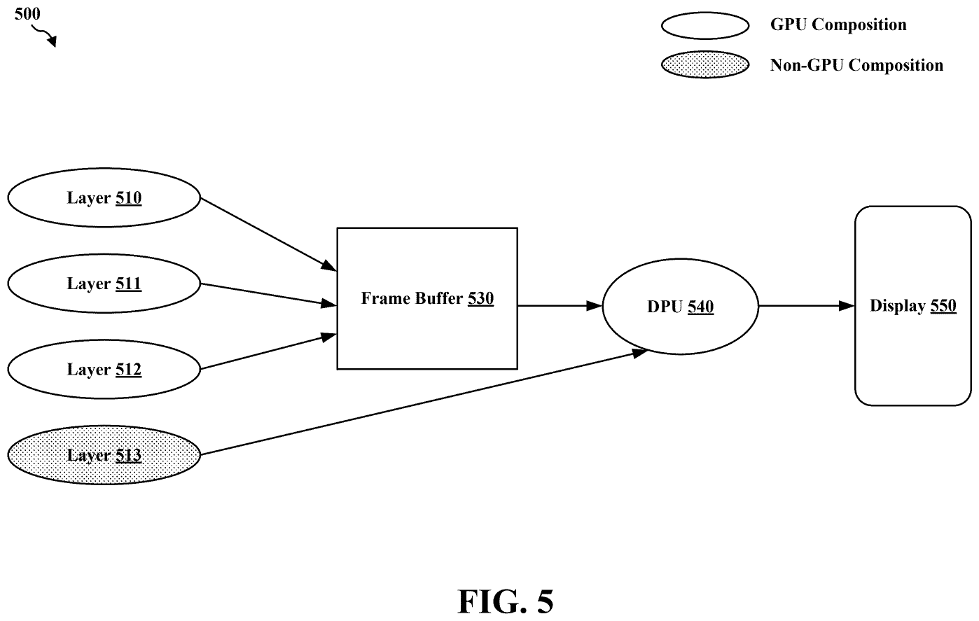

FIG. 5 is a diagram 500 illustrating an example of a layer composition scheme for display processing. More specifically, diagram 500 depicts a layer composition of display layers where certain layers (e.g., layers of a certain composition) are cached in a frame buffer, and some layers are directly fetched and composed by a DPU. As shown in FIG. 5, diagram 500 includes layer 510, layer 511, layer 512, layer 513, frame buffer 530 (e.g., an RGBA8888 format frame buffer), DPU 540, and display 550. FIG. 5 depicts that layers composed at a GPU (i.e., layers associated with GPU composition) may be cached or stored in a frame buffer. For example, layer 510, layer 511, and layer 512 may be composed at a GPU and then cached/stored at frame buffer 530. Alternatively, layers that are not composed at a GPU (i.e., layers associated with non-GPU composition) may be directly fetched and composed at a DPU. For instance, layer 513 may be directly fetched and composed at DPU 540. That is, layer 510, layer 511, and layer 512 may be a certain type of composition (e.g., GPU composition), while layer 513 may be another type of composition (non-GPU composition). After being cached/stored in frame buffer 530, the layer 510, layer 511, and layer 512 may be sent to DPU 540. Further, after processing at DPU 540, the layers 510-513 may be sent to display 550.

Some types of display processing devices (e.g., mobile devices, computers, TVs, or other consumer devices) may utilize complex multiple content layouts in a single display processing layer. That is, for graphics or display stacks in operating systems of the devices, there may be a single display processing layer (i.e., display layer or layer that is associated with display processing). For instance, there may be at least one display layer that may be associated with a screen or frame for a display processing device, such that the display panel at the device may be divided amongst the display layers. Additionally, for content or end users, there may be multiple content entities in the display processing layer. This may be due to operating system limitations and/or application rendering/resource management limitations. Using a single display processing layer may provide an application with an improved performance and/or flexibility. Further, some types of applications may choose to render in using a single display processing layer. Additionally, it may be beneficial to provide a color processing capability on a per-region basis (i.e., for each region of interest (ROI) in a layer). Color processing capability on a per-region basis may be utilized with certain types of display processing unit (DPU) architecture. Moreover, it may be beneficial for devices to provide color processing at multiple sub-layer levels (i.e., for different ROIs in a layer) within a single display processing layer.

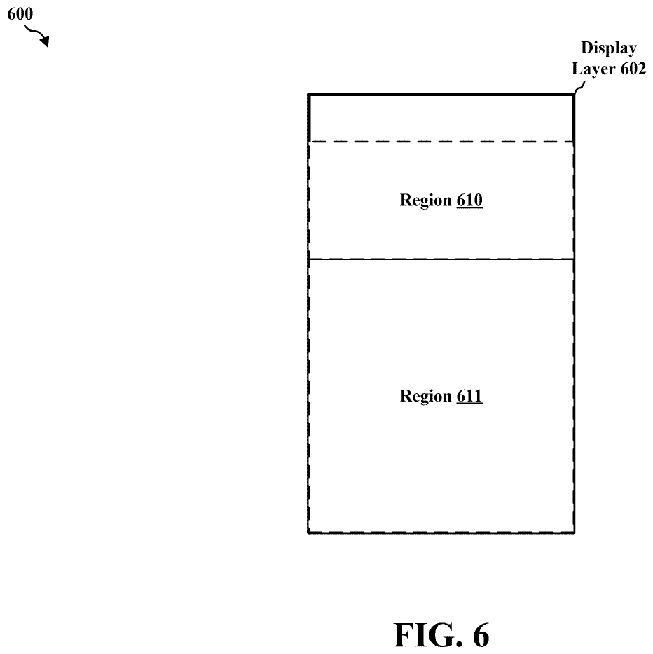

FIG. 6 is a diagram 600 illustrating an example of a layer for display processing. More specifically, diagram 600 depicts a display layer 602 (e.g., a layer of a certain composition) in a screen or frame at a display device. Additionally, the display layers at a display device may include different areas or regions of interest (ROIs). As shown in FIG. 6, display layer 602 includes region 610 and region 611. Each of the region 610 and region 611 may be associated with a region of interest (ROI) or a region for color processing.

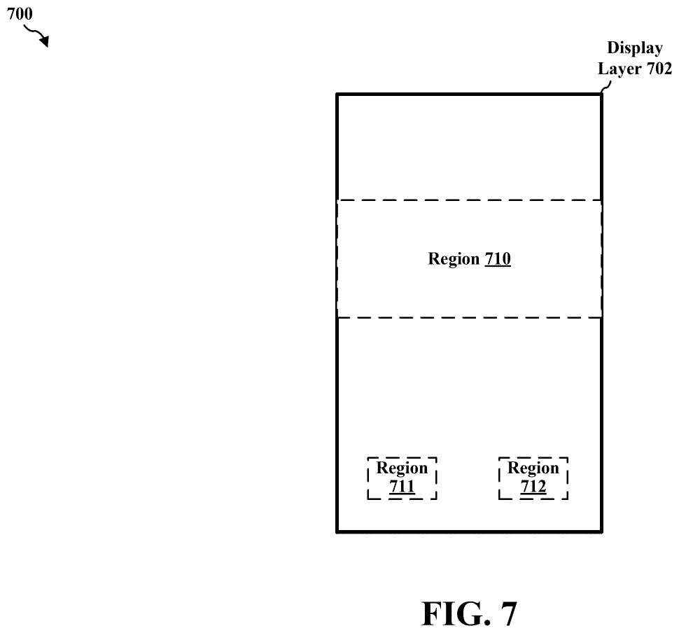

FIG. 7 is a diagram 700 illustrating another example of a layer for display processing. More specifically, diagram 700 depicts a display layer 702 (e.g., a layer of a certain composition) in a screen or frame at a display device, where the layer includes different areas or ROIs. As shown in FIG. 7, display layer 702 includes region 710, region 711, and region 712. Each of the region 710, region 711, and region 712 may be associated with a region of interest (ROI) (e.g., a ROI for color processing) or an area in the layer. FIGS. 6 and 7 show examples of different regions or ROIs for a display layer in a screen or frame.

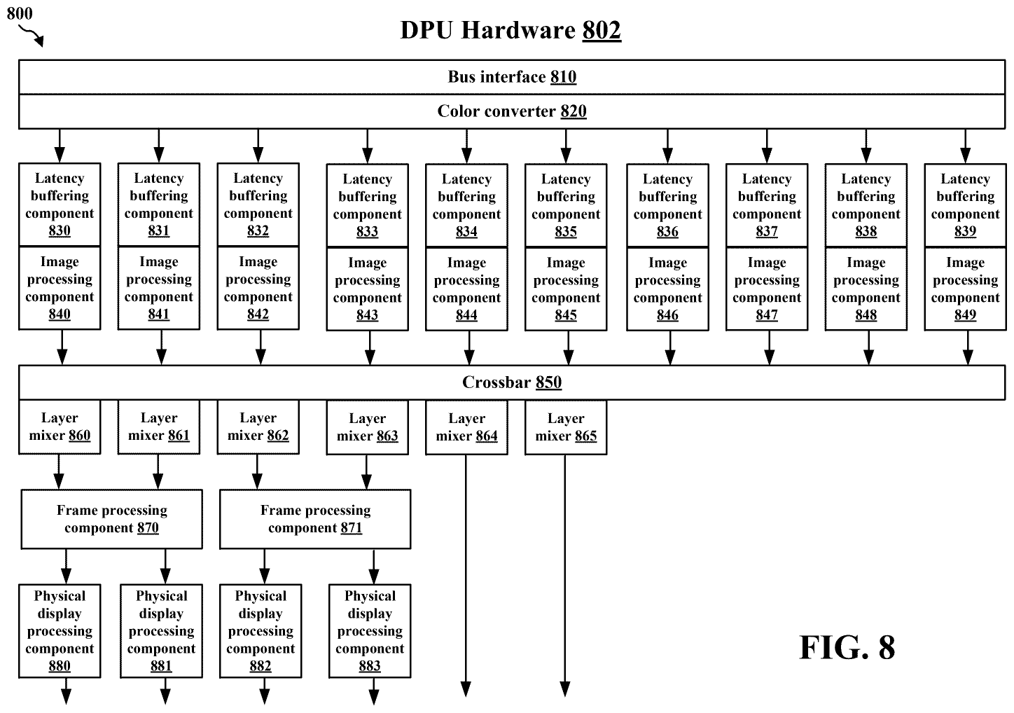

FIG. 8 is a diagram 800 illustrating an example DPU hardware for display processing. More specifically, diagram 800 depicts DPU hardware 802 that is used to support different types of display processing, such as image processing or color processing. As shown in FIG. 8, DPU hardware 802 includes bus interface 810, color converter 820, multiple latency buffering components (e.g., latency buffering component 830, latency buffering component 831, latency buffering component 832, latency buffering component 833, latency buffering component 834, latency buffering component 835, latency buffering component 836, latency buffering component 837, latency buffering component 838, and latency buffering component 839) and multiple image processing components (e.g., image processing component 840, image processing component 841, image processing component 842, image processing component 843, image processing component 844, image processing component 845, image processing component 846, image processing component 847, image processing component 848, and image processing component 849). DPU hardware 802 also includes crossbar 850, multiple layer mixers (e.g., layer mixer 860, layer mixer 861, layer mixer 862, layer mixer 863, layer mixer 864, and layer mixer 865), frame processing components (e.g., frame processing component 870 and frame processing component 871), and multiple physical display processing components (e.g., physical display processing component 880, physical display processing component 881, physical display processing component 882, and physical display processing component 883).

In some instances, certain aspects of a DPU (e.g., DPU hardware) may process layers and/or utilize layers as a basic processing unit in a display processing operation. That is, DPU hardware may provide support for image processing or color processing on a per-layer basis. However, some types of DPU hardware may not support image processing or color processing for multiple sub-layer ROIs. For example, DPU hardware may provide image processing for a per-layer granularity, but may not be able to provide support for multiple sub-layer ROIs for image processing or color processing. Accordingly, it may be beneficial to provide image processing or color processing for multiple sub-layer ROIs within a display layer. For instance, it may be beneficial to provide DPU hardware that supports image/color processing for multiple sub-layer ROIs within a single layer.

Aspects of the present disclosure may provide the capability to perform image or color processing on a per-region basis within a display layer. That is, aspects presented herein may support image or color processing for each region of interest (ROI) in a single display layer. For instance, aspects of the present disclosure may support image or color processing at multiple sub-layer levels (i.e., for different ROIs in a layer) within a single display layer. For example, aspects of the present disclosure may provide support in DPU hardware to allow for image/color processing for multiple sub-layer ROIs within a single display layer. Additionally, in some instances, aspects of the present disclosure may provide a solution to single layer image processing specifications for certain types of applications. For instance, a single display processing layer may provide an application with an improved performance and/or flexibility. As such, aspects presented herein may provide a solution for advanced display processing conditions, as well as help to improve performance and/or flexibility in display processing.

In some instances, aspects of the present disclosure may divide a single display layer into multiple composition stages for image/color processing. For instance, a single display layer may be divided into multiple regions or ROIs for image/color processing at DPU hardware. The specific layout information for ROIs in a display layer may be obtained using a number of different procedures. For example, the layout information for ROIs in a display layer may be obtained from operating system framework resources and/or a layout management service. Additionally, an application or game may provide the position/location information or coordinates for the layout information of ROIs in a display layer. Further, the layout information for ROIs in a display layer may be obtained based on a run-time layer content analysis.

In some aspects presented herein, for each region or ROI in a single layer, the region or ROI may be assigned or allocated to a corresponding composition stage. Also, the region or ROI may be assigned to one component in a DPU pipeline (e.g., a processing pipe or source surface processor pipe (SSPP)) for specific image/color post processing. This assignment or allocation may be based on other types of components (e.g., a three-dimensional (3D) lookup table (LUT) or other component for display processing). The DPU hardware may fetch the region or ROI for the layer and perform the specific processing and composition. This region or ROI may be assigned to a higher level in a display hierarchy (i.e., Z order or Z-order) compared to an original layer display hierarchy. A Z-order may refer to a process for sorting which items in a display application appear visually in front of other items. After this, in the next composition stages, the entire layer (i.e., excluding previous regions or ROIs) may be fetched and composed at lower level in the display hierarchy (i.e., Z order or Z-order). For instance, the layer may be assigned to a lower level in the display hierarchy as it corresponds to a background layer. Accordingly, a single display layer may be split into multiple sub-layer regions or ROIs and additional composition stages may be added for any new sub-layers (i.e., logically added new sub-layers).

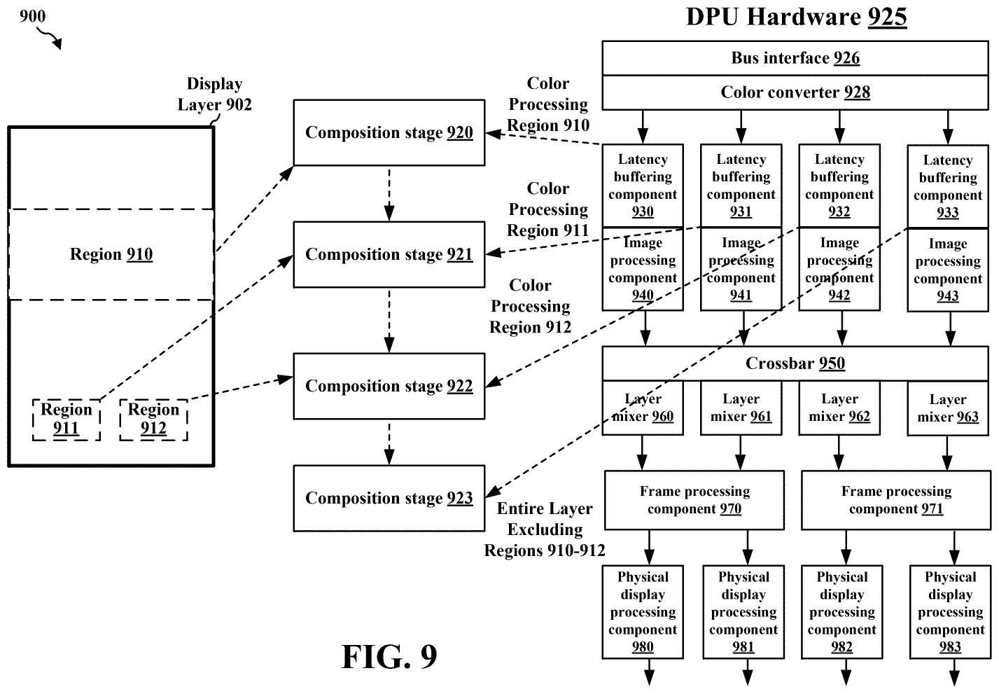

FIG. 9 is a diagram 900 illustrating an example of a layer composition scheme for display processing. More specifically, diagram 900 depicts a composition scheme including a display layer 902 with different ROIs, corresponding composition stages, and corresponding components in DPU hardware 925. As shown in FIG. 9, diagram 900 includes display layer 902 with several regions or ROIs (e.g., region 910, region 911, and region 912), as well as multiple composition stages (e.g., composition stage 920, composition stage 921, composition stage 922, and composition stage 923). Also, as illustrated in FIG. 9, DPU hardware 925 includes bus interface 926, color converter 928, multiple latency buffering components (e.g., latency buffering component 930, latency buffering component 931, latency buffering component 932, and latency buffering component 933) and multiple image processing components (e.g., image processing component 940, image processing component 941, image processing component 942, and image processing component 943). DPU hardware 925 also includes crossbar 950, multiple layer mixers (e.g., layer mixer 960, layer mixer 961, layer mixer 962, and layer mixer 963), frame processing components (e.g., frame processing component 970 and frame processing component 971), and multiple physical display processing components (e.g., physical display processing component 980, physical display processing component 981, physical display processing component 982, and physical display processing component 983). Although not shown in FIG. 9, DPU hardware 925 may include all of the same components (and the same number of components) as DPU hardware 802 in FIG. 8. In some aspects, the latency buffering components or image processing component may correspond to a processing pipe or a source surface processor pipe (SSPP)) in a DPU.

As depicted in FIG. 9, the display layer 902 may be included in multiple display layers that are obtained from a GPU, a CPU, an application, or a game. For instance, a DPU may obtain a plurality of layers (including display layer 902) that are associated with at least one screen or frame at a display device, where each layer of the plurality of layers includes a set of layer regions or ROIs, and where each of the set of layer regions or ROIs include a plurality of pixels. Each of the layer regions in display layer 902 (e.g., region 910, region 911, and region 912) may correspond to a specific component in DPU hardware 925 (e.g., one of the latency buffering components 930-933 or the image processing components 940-943) and/or a specific composition stage (e.g., one of composition stages 920-923). For instance, each of a set of layer regions may be assigned to a corresponding component in a set of components in a DPU pipeline. For example, region 910 may be assigned or allocated to latency buffering component 930 or image processing component 940, region 911 may be assigned or allocated to latency buffering component 931 or image processing component 941, and region 912 may be assigned or allocated to latency buffering component 932 or image processing component 942. After this, a portion of the pixels in at least one layer region may be adjusted with the corresponding component. For example, a portion of the pixels in region 910 may be adjusted with latency buffering component 930 or image processing component 940, a portion of the pixels in region 911 may be adjusted with latency buffering component 931 or image processing component 941, and/or a portion of the pixels in region 912 may be adjusted with latency buffering component 932 or image processing component 942.

As shown in FIG. 9, the regions or ROIs may also be associated with a specific composition stage. For example, region 910 may be associated with composition stage 920, region 911 may be associated with composition stage 921, and region 912 may be associated with composition stage 922. The composition stage may also be associated with the corresponding component that adjusted the portion of the pixels in at least one layer region. For instance, the corresponding component may be associated with a composition stage (e.g., composition stages 920-923) for a specific color processing region (e.g., regions 910-912). For example, latency buffering component 930 or image processing component 940 may be associated with composition stage 920 for region 910, latency buffering component 931 or image processing component 941 may be associated with composition stage 921 for region 911, and latency buffering component 932 or image processing component 942 may be associated with composition stage 922 for region 912. That is, the DPU may compose the set of layer regions (e.g., regions 910-912) including the at least one layer region with the adjusted portion of the plurality of pixels. Also, the entire layer excluding the regions or ROIs (e.g., regions 910-912) may be associated with a corresponding component (e.g., latency buffering component 933 or image processing component 943), as well as a composition stage (e.g., composition stage 923). The composition stage (composition stages 920-923) may include a blending stage, such that composing the set of layer regions including the at least one layer region with the adjusted portion of the plurality of pixels may include: blending at least some of the set of layer regions including the at least one layer region with the adjusted portion of the plurality of pixels. Additionally, the composition of the set of layer regions may result in an output of the composition of the set of layer regions, and the DPU may process the output of the composition of the set of layer regions after the set of layer regions is composed.

Aspects of the present disclosure may include a number of benefits or advantages. For instance, aspects presented herein may utilize DPU hardware to provide a multiple color/image ROI processing solution for a single display layer. That is, aspects presented herein may support image or color processing for each region or ROI in a single display layer. For instance, aspects of the present disclosure may support image or color processing at multiple sub-layer levels (i.e., for different ROIs in a layer) within a single display layer. For example, aspects of the present disclosure may provide support in DPU hardware to allow for image/color processing for multiple sub-layer ROIs within a single display layer. Additionally, in some instances, aspects of the present disclosure may provide a solution to single layer image processing specifications for certain types of applications or games. That is, aspects presented herein may solve the single layer image processing specifications for different applications or games. For instance, a single display processing layer may provide an application or game with an improved performance and/or flexibility. As such, aspects presented herein may provide a solution for advanced display processing conditions, as well as help to improve performance and/or flexibility in display processing. In some instances, aspects presented herein may adjust layer stacks and/or composition stages (e.g., mixing stages) in order to add the regions or ROIs of a single display layer into the layer stacks and/or composition stages.

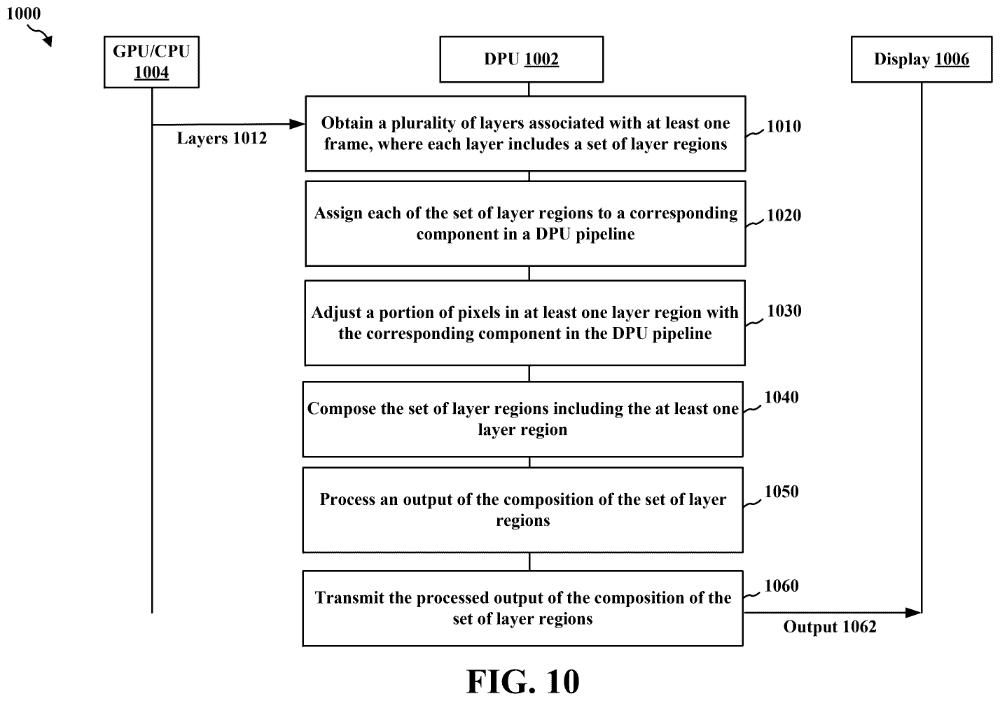

FIG. 10 is a communication flow diagram 1000 of display processing in accordance with one or more techniques of this disclosure. As shown in FIG. 10, diagram 1000 includes example communications between DPU 1002 (or other display processor), GPU/CPU 1004, and display 1006, in accordance with one or more techniques of this disclosure.

At 1010, DPU 1002 may obtain a plurality of layers associated with at least one frame (e.g., DPU 1002 may obtain layers 1012 from GPU/CPU 1004), where each layer of the plurality of layers includes a set of layer regions, where each of the set of layer regions includes a plurality of pixels. In some aspects, obtaining the plurality of layers may include: receiving the plurality of layers from at least one of a graphics processing unit (GPU), a central processing unit (CPU), an application, or a game. For instance, the DPU may receive the plurality of layers from at least one of a GPU, a CPU, an application, or a game. The set of layer regions in each of the plurality of layers may correspond to a set of portions for each of the plurality of layers or a set of regions of interest (ROI) for each of the plurality of layers. Further, the at least one frame may be associated with at least one of: display processing, image processing, frame processing, or color processing. In some aspects, the plurality of pixels in each of the set of layer regions may be associated with metadata, a layer hierarchy, a Z-order, or a Z-coordinate. Also, each of the set of layer regions may include a corresponding pixel resolution, such that the corresponding pixel resolution of at least one first layer region in the set of layer regions is different from the corresponding pixel resolution of at least one second layer region in the set of layer regions.

At 1020, DPU 1002 may assign each of the set of layer regions to a corresponding component in a set of components in a display processing unit (DPU) pipeline. In some aspects, assigning each of the set of layer regions to the corresponding component in the set of components may include: mapping each of the set of layer regions to the corresponding component in the set of components, such that each of the set of layer regions is assigned to the corresponding component based on the mapping. For instance, the DPU may map each of the set of layer regions to the corresponding component in the set of components. Each of the set of layer regions may be mapped to the corresponding component in the set of components based on a corresponding processing task associated with each of the set of layer regions. Also, each of the set of layer regions may be mapped to the corresponding component in the set of components based on a position of each of the set of layer regions or a set of coordinates for each of the set of layer regions.

At 1030, DPU 1002 may adjust a portion of the plurality of pixels in at least one layer region of the set of layer regions with the corresponding component in the set of components in the DPU pipeline. In some aspects, the portion of the plurality of pixels in the at least one layer region may be adjusted based on processing the plurality of pixels in the at least one layer region. Also, the plurality of pixels in the at least one layer region may be processed based on the display processing, image processing, frame processing, or color processing.

At 1040, DPU 1002 may compose the set of layer regions including the at least one layer region with the adjusted portion of the plurality of pixels. In some aspects, composing the set of layer regions including the at least one layer region with the adjusted portion of the plurality of pixels may include: blending at least some of the set of layer regions including the at least one layer region with the adjusted portion of the plurality of pixels. For instance, the DPU may blend at least some of the set of layer regions including the at least one layer region with the adjusted portion of the plurality of pixels.

At 1050, DPU 1002 may process an output of the composition of the set of layer regions after the set of layer regions is composed, where the composition of the set of layer regions results in the output of the composition of the set of layer regions. In some aspects, processing the output of the composition of the set of layer regions may include: adjusting a pixel value for each of the plurality of pixels in the output of the composition of the set of layer regions. For instance, the DPU may adjust a pixel value for each of the plurality of pixels in the output of the composition of the set of layer regions.

At 1060, DPU 1002 may transmit the processed output of the composition of the set of layer regions (e.g., DPU 1002 may transmit output 1062 to display 1006). The processed output of the composition of the set of layer regions may be transmitted to a display or a panel.

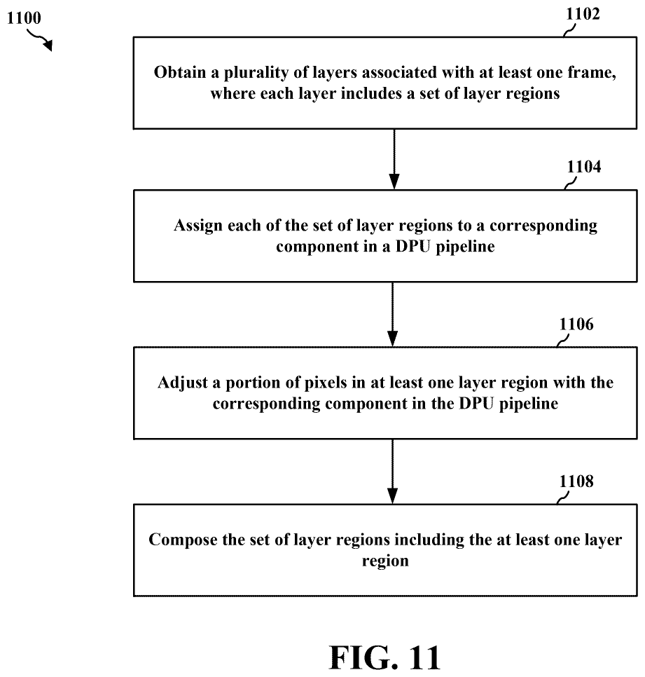

FIG. 11 is a flowchart 1100 of an example method of display processing in accordance with one or more techniques of this disclosure. The method may be performed by a DPU (or other display processor), a GPU (or other graphics processor), a CPU (or other central processor), a DDIC, an apparatus for display processing, a wireless communication device, and/or any apparatus that may perform display processing as used in connection with the examples of FIGS. 1-10.

At 1102, the DPU may obtain a plurality of layers associated with at least one frame, where each layer of the plurality of layers includes a set of layer regions, where each of the set of layer regions includes a plurality of pixels, as described in connection with the examples in FIGS. 1-10. For example, as described in 1010 of FIG. 10, DPU 1002 may obtain a plurality of layers associated with at least one frame, where each layer of the plurality of layers includes a set of layer regions, where each of the set of layer regions includes a plurality of pixels. Further, step 1102 may be performed by display processor 127 in FIG. 1. In some aspects, obtaining the plurality of layers may include: receiving the plurality of layers from at least one of a graphics processing unit (GPU), a central processing unit (CPU), an application, or a game. For instance, the DPU may receive the plurality of layers from at least one of a GPU, a CPU, an application, or a game. The set of layer regions in each of the plurality of layers may correspond to a set of portions for each of the plurality of layers or a set of regions of interest (ROI) for each of the plurality of layers. Further, the at least one frame may be associated with at least one of: display processing, image processing, frame processing, or color processing. In some aspects, the plurality of pixels in each of the set of layer regions may be associated with metadata, a layer hierarchy, a Z-order, or a Z-coordinate. Also, each of the set of layer regions may include a corresponding pixel resolution, such that the corresponding pixel resolution of at least one first layer region in the set of layer regions is different from the corresponding pixel resolution of at least one second layer region in the set of layer regions.

At 1104, the DPU may assign each of the set of layer regions to a corresponding component in a set of components in a display processing unit (DPU) pipeline, as described in connection with the examples in FIGS. 1-10. For example, as described in 1020 of FIG. 10, DPU 1002 may assign each of the set of layer regions to a corresponding component in a set of components in a display processing unit (DPU) pipeline. Further, step 1104 may be performed by display processor 127 in FIG. 1. In some aspects, assigning each of the set of layer regions to the corresponding component in the set of components may include: mapping each of the set of layer regions to the corresponding component in the set of components, such that each of the set of layer regions is assigned to the corresponding component based on the mapping. For instance, the DPU may map each of the set of layer regions to the corresponding component in the set of components. Each of the set of layer regions may be mapped to the corresponding component in the set of components based on a corresponding processing task associated with each of the set of layer regions. Also, each of the set of layer regions may be mapped to the corresponding component in the set of components based on a position of each of the set of layer regions or a set of coordinates for each of the set of layer regions.

At 1106, the DPU may adjust a portion of the plurality of pixels in at least one layer region of the set of layer regions with the corresponding component in the set of components in the DPU pipeline, as described in connection with the examples in FIGS. 1-10. For example, as described in 1030 of FIG. 10, DPU 1002 may adjust a portion of the plurality of pixels in at least one layer region of the set of layer regions with the corresponding component in the set of components in the DPU pipeline. Further, step 1106 may be performed by display processor 127 in FIG. 1. In some aspects, the portion of the plurality of pixels in the at least one layer region may be adjusted based on processing the plurality of pixels in the at least one layer region. Also, the plurality of pixels in the at least one layer region may be processed based on the display processing, image processing, frame processing, or color processing.

At 1108, the DPU may compose the set of layer regions including the at least one layer region with the adjusted portion of the plurality of pixels, as described in connection with the examples in FIGS. 1-10. For example, as described in 1040 of FIG. 10, DPU 1002 may compose the set of layer regions including the at least one layer region with the adjusted portion of the plurality of pixels. Further, step 1108 may be performed by display processor 127 in FIG. 1. In some aspects, composing the set of layer regions including the at least one layer region with the adjusted portion of the plurality of pixels may include: blending at least some of the set of layer regions including the at least one layer region with the adjusted portion of the plurality of pixels. For instance, the DPU may blend at least some of the set of layer regions including the at least one layer region with the adjusted portion of the plurality of pixels.

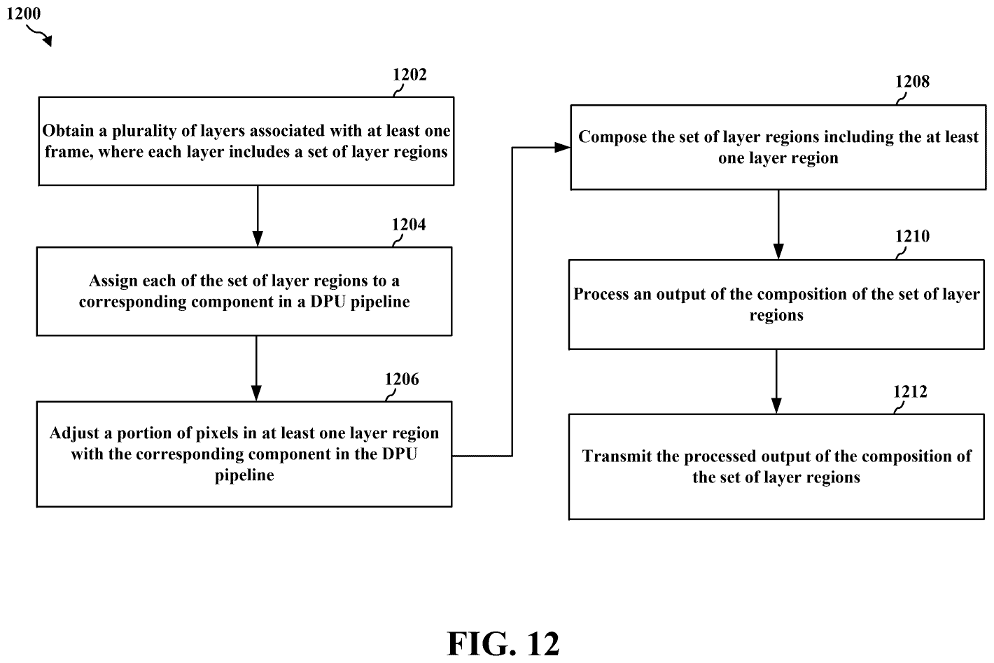

FIG. 12 is a flowchart 1200 of an example method of display processing in accordance with one or more techniques of this disclosure. The method may be performed by a DPU (or other display processor), a GPU (or other graphics processor), a CPU (or other central processor), a DDIC, an apparatus for display processing, a wireless communication device, and/or any apparatus that may perform display processing as used in connection with the examples of FIGS. 1-10.

At 1202, the DPU may obtain a plurality of layers associated with at least one frame, where each layer of the plurality of layers includes a set of layer regions, where each of the set of layer regions includes a plurality of pixels, as described in connection with the examples in FIGS. 1-10. For example, as described in 1010 of FIG. 10, DPU 1002 may obtain a plurality of layers associated with at least one frame, where each layer of the plurality of layers includes a set of layer regions, where each of the set of layer regions includes a plurality of pixels. Further, step 1202 may be performed by display processor 127 in FIG. 1. In some aspects, obtaining the plurality of layers may include: receiving the plurality of layers from at least one of a graphics processing unit (GPU), a central processing unit (CPU), an application, or a game. For instance, the DPU may receive the plurality of layers from at least one of a GPU, a CPU, an application, or a game. The set of layer regions in each of the plurality of layers may correspond to a set of portions for each of the plurality of layers or a set of regions of interest (ROI) for each of the plurality of layers. Further, the at least one frame may be associated with at least one of: display processing, image processing, frame processing, or color processing. In some aspects, the plurality of pixels in each of the set of layer regions may be associated with metadata, a layer hierarchy, a Z-order, or a Z-coordinate. Also, each of the set of layer regions may include a corresponding pixel resolution, such that the corresponding pixel resolution of at least one first layer region in the set of layer regions is different from the corresponding pixel resolution of at least one second layer region in the set of layer regions.

At 1204, the DPU may assign each of the set of layer regions to a corresponding component in a set of components in a display processing unit (DPU) pipeline, as described in connection with the examples in FIGS. 1-10. For example, as described in 1020 of FIG. 10, DPU 1002 may assign each of the set of layer regions to a corresponding component in a set of components in a display processing unit (DPU) pipeline. Further, step 1204 may be performed by display processor 127 in FIG. 1. In some aspects, assigning each of the set of layer regions to the corresponding component in the set of components may include: mapping each of the set of layer regions to the corresponding component in the set of components, such that each of the set of layer regions is assigned to the corresponding component based on the mapping. For instance, the DPU may map each of the set of layer regions to the corresponding component in the set of components. Each of the set of layer regions may be mapped to the corresponding component in the set of components based on a corresponding processing task associated with each of the set of layer regions. Also, each of the set of layer regions may be mapped to the corresponding component in the set of components based on a position of each of the set of layer regions or a set of coordinates for each of the set of layer regions.

At 1206, the DPU may adjust a portion of the plurality of pixels in at least one layer region of the set of layer regions with the corresponding component in the set of components in the DPU pipeline, as described in connection with the examples in FIGS. 1-10. For example, as described in 1030 of FIG. 10, DPU 1002 may adjust a portion of the plurality of pixels in at least one layer region of the set of layer regions with the corresponding component in the set of components in the DPU pipeline. Further, step 1206 may be performed by display processor 127 in FIG. 1. In some aspects, the portion of the plurality of pixels in the at least one layer region may be adjusted based on processing the plurality of pixels in the at least one layer region. Also, the plurality of pixels in the at least one layer region may be processed based on the display processing, image processing, frame processing, or color processing.

At 1208, the DPU may compose the set of layer regions including the at least one layer region with the adjusted portion of the plurality of pixels, as described in connection with the examples in FIGS. 1-10. For example, as described in 1040 of FIG. 10, DPU 1002 may compose the set of layer regions including the at least one layer region with the adjusted portion of the plurality of pixels. Further, step 1208 may be performed by display processor 127 in FIG. 1. In some aspects, composing the set of layer regions including the at least one layer region with the adjusted portion of the plurality of pixels may include: blending at least some of the set of layer regions including the at least one layer region with the adjusted portion of the plurality of pixels. For instance, the DPU may blend at least some of the set of layer regions including the at least one layer region with the adjusted portion of the plurality of pixels.

At 1210, the DPU may process an output of the composition of the set of layer regions after the set of layer regions is composed, where the composition of the set of layer regions results in the output of the composition of the set of layer regions, as described in connection with the examples in FIGS. 1-10. For example, as described in 1050 of FIG. 10, DPU 1002 may process an output of the composition of the set of layer regions after the set of layer regions is composed, where the composition of the set of layer regions results in the output of the composition of the set of layer regions. Further, step 1210 may be performed by display processor 127 in FIG. 1. In some aspects, processing the output of the composition of the set of layer regions may include: adjusting a pixel value for each of the plurality of pixels in the output of the composition of the set of layer regions. For instance, the DPU may adjust a pixel value for each of the plurality of pixels in the output of the composition of the set of layer regions.

At 1212, the DPU may transmit the processed output of the composition of the set of layer regions, as described in connection with the examples in FIGS. 1-10. For example, as described in 1060 of FIG. 10, DPU 1002 may transmit the processed output of the composition of the set of layer regions. Further, step 1212 may be performed by display processor 127 in FIG. 1. The processed output of the composition of the set of layer regions may be transmitted to a display or a panel.

In configurations, a method or an apparatus for display processing is provided. The apparatus may be a DPU (or other display processor), a GPU (or other graphics processor), a CPU (or other central processor), a DDIC, an apparatus for display processing, and/or some other processor that may perform display processing. In aspects, the apparatus may be the display processor 127 within the device 104, or may be some other hardware within the device 104 or another device. The apparatus, e.g., display processor 127, may include means for obtaining a plurality of layers associated with at least one frame, where each layer of the plurality of layers includes a set of layer regions, where each of the set of layer regions includes a plurality of pixels. The apparatus, e.g., display processor 127, may also include means for assigning each of the set of layer regions to a corresponding component in a set of components in a display processing unit (DPU) pipeline. The apparatus, e.g., display processor 127, may also include means for adjusting a portion of the plurality of pixels in at least one layer region of the set of layer regions with the corresponding component in the set of components in the DPU pipeline. The apparatus, e.g., display processor 127, may also include means for composing the set of layer regions including the at least one layer region with the adjusted portion of the plurality of pixels. The apparatus, e.g., display processor 127, may also include means for processing an output of the composition of the set of layer regions after the set of layer regions is composed. The apparatus, e.g., display processor 127, may also include means for transmitting the processed output of the composition of the set of layer regions.

The subject matter described herein may be implemented to realize one or more benefits or advantages. For instance, the described display processing techniques may be used by a DPU, a display processor, a GPU, a CPU, or some other processor that may perform display processing to implement the ROI processing composition techniques described herein. This may also be accomplished at a low cost compared to other display processing techniques. Moreover, the display processing techniques herein may improve or speed up data processing or execution. Further, the display processing techniques herein may improve resource or data utilization and/or resource efficiency. Additionally, aspects of the present disclosure may utilize ROI processing composition techniques in order to improve memory bandwidth efficiency and/or increase processing speed at a DPU or a GPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for display processing, including a memory and at least one processor coupled to the memory and, based at least in part on information stored in the memory, the at least one processor is configured to: obtain a plurality of layers associated with at least one frame, where each layer of the plurality of layers includes a set of layer regions, where each of the set of layer regions includes a plurality of pixels; assign each of the set of layer regions to a corresponding component in a set of components in a display processing unit (DPU) pipeline; adjust a portion of the plurality of pixels in at least one layer region of the set of layer regions with the corresponding component in the set of components in the DPU pipeline; and compose the set of layer regions including the at least one layer region with the adjusted portion of the plurality of pixels.

Aspect 2 is the apparatus of aspect 1, where to assign each of the set of layer regions to the corresponding component in the set of components, the at least one processor is configured to: map each of the set of layer regions to the corresponding component in the set of components, such that each of the set of layer regions is assigned to the corresponding component based on the mapping.

Aspect 3 is the apparatus of aspect 2, where each of the set of layer regions is mapped to the corresponding component in the set of components based on a corresponding processing task associated with each of the set of layer regions.

Aspect 4 is the apparatus of aspect 2, where each of the set of layer regions is mapped to the corresponding component in the set of components based on a position of each of the set of layer regions or a set of coordinates for each of the set of layer regions.

Aspect 5 is the apparatus of any of aspects 1 to 4, where the composition of the set of layer regions results in an output of the composition of the set of layer regions, and where the at least one processor is further configured to: process the output of the composition of the set of layer regions after the set of layer regions is composed.

Aspect 6 is the apparatus of aspect 5, where to process the output of the composition of the set of layer regions, the at least one processor is configured to: adjust a pixel value for each of the plurality of pixels in the output of the composition of the set of layer regions.

Aspect 7 is the apparatus of aspect 5, where the at least one processor is further configured to: transmit the processed output of the composition of the set of layer regions.

Aspect 8 is the apparatus of aspect 7, where the processed output of the composition of the set of layer regions is transmitted to a display or a panel.

Aspect 9 is the apparatus of any of aspects 1 to 8, where to compose the set of layer regions including the at least one layer region with the adjusted portion of the plurality of pixels, the at least one processor is configured to: blend at least some of the set of layer regions including the at least one layer region with the adjusted portion of the plurality of pixels.

Aspect 10 is the apparatus of any of aspects 1 to 9, where the portion of the plurality of pixels in the at least one layer region is adjusted based on processing the plurality of pixels in the at least one layer region.

Aspect 11 is the apparatus of aspect 10, where the plurality of pixels in the at least one layer region is processed based on the display processing, image processing, frame processing, or color processing.

Aspect 12 is the apparatus of any of aspects 1 to 11, where the set of layer regions in each of the plurality of layers corresponds to a set of portions for each of the plurality of layers or a set of regions of interest (ROI) for each of the plurality of layers.

Aspect 13 is the apparatus of any of aspects 1 to 12, where the plurality of pixels in each of the set of layer regions is associated with metadata, a layer hierarchy, a Z-order, or a Z-coordinate.

Aspect 14 is the apparatus of any of aspects 1 to 13, where each of the set of layer regions includes a corresponding pixel resolution, such that the corresponding pixel resolution of at least one first layer region in the set of layer regions is different from the corresponding pixel resolution of at least one second layer region in the set of layer regions.

Aspect 15 is the apparatus of any of aspects 1 to 14, where to obtain the plurality of layers, the at least one processor is configured to: receive the plurality of layers from at least one of: a graphics processing unit (GPU), a central processing unit (CPU), an application, or a game.

Aspect 16 is the apparatus of any of aspects 1 to 15, where the at least one frame is associated with at least one of: the display processing, image processing, frame processing, or color processing.

Aspect 17 is the apparatus of any of aspects 1 to 16, where the apparatus is a wireless communication device, further including at least one of an antenna or a transceiver coupled to the at least one processor, where the at least one processor is configured to obtain the plurality of layers via at least one of the antenna or the transceiver.

Aspect 18 is a method of display processing for implementing any of aspects 1 to 17.

Aspect 19 is an apparatus for display processing including means for implementing any of aspects 1 to 17.

Aspect 20 is a computer-readable medium (e.g., a non-transitory computer-readable medium) storing computer executable code, the code when executed by at least one processor causes the at least one processor to implement any of aspects 1 to 17.

What is claimed is:

1. An apparatus for display processing, comprising:
a memory; and
at least one processor coupled to the memory and, based at least in part on information stored in the memory, the at least one processor is configured to:
obtain a plurality of layers associated with at least one frame, wherein each layer of the plurality of layers includes a set of layer regions, wherein each of the set of layer regions includes a plurality of pixels;
assign each of the set of layer regions to a corresponding component in a set of components in a display processing unit (DPU) pipeline;
adjust a portion of the plurality of pixels in at least one layer region of the set of layer regions with the corresponding component in the set of components in the DPU pipeline; and
compose the set of layer regions including the at least one layer region with the adjusted portion of the plurality of pixels.

2. The apparatus of claim 1, wherein to assign each of the set of layer regions to the corresponding component in the set of components, the at least one processor is configured to:
map each of the set of layer regions to the corresponding component in the set of components, such that each of the set of layer regions is assigned to the corresponding component based on the mapping.

3. The apparatus of claim 2, wherein each of the set of layer regions is mapped to the corresponding component in the set of components based on a corresponding processing task associated with each of the set of layer regions.

4. The apparatus of claim 2, wherein each of the set of layer regions is mapped to the corresponding component in the set of components based on a position of each of the set of layer regions or a set of coordinates for each of the set of layer regions.

5. The apparatus of claim 1, wherein the composition of the set of layer regions results in an output of the composition of the set of layer regions, and wherein the at least one processor is further configured to:
process the output of the composition of the set of layer regions after the set of layer regions is composed.

6. The apparatus of claim 5, wherein to process the output of the composition of the set of layer regions, the at least one processor is configured to:
adjust a pixel value for each of the plurality of pixels in the output of the composition of the set of layer regions.

7. The apparatus of claim 5, wherein the at least one processor is further configured to:
transmit the processed output of the composition of the set of layer regions.

8. The apparatus of claim 7, wherein the processed output of the composition of the set of layer regions is transmitted to a display or a panel.

9. The apparatus of claim 1, wherein to compose the set of layer regions including the at least one layer region with the adjusted portion of the plurality of pixels, the at least one processor is configured to:
blend at least some of the set of layer regions including the at least one layer region with the adjusted portion of the plurality of pixels.

10. The apparatus of claim 1, wherein the portion of the plurality of pixels in the at least one layer region is adjusted based on processing the plurality of pixels in the at least one layer region.

11. The apparatus of claim 10, wherein the plurality of pixels in the at least one layer region is processed based on the display processing, image processing, frame processing, or color processing.

12. The apparatus of claim 1, wherein the set of layer regions in each of the plurality of layers corresponds to a set of portions for each of the plurality of layers or a set of regions of interest (ROI) for each of the plurality of layers.

13. The apparatus of claim 1, wherein the plurality of pixels in each of the set of layer regions is associated with metadata, a layer hierarchy, a Z-order, or a Z-coordinate.

14. The apparatus of claim 1, wherein each of the set of layer regions includes a corresponding pixel resolution, such that the corresponding pixel resolution of at least one first layer region in the set of layer regions is different from the corresponding pixel resolution of at least one second layer region in the set of layer regions.

15. The apparatus of claim 1, wherein to obtain the plurality of layers, the at least one processor is configured to: receive the plurality of layers from at least one of: a graphics processing unit (GPU), a central processing unit (CPU), an application, or a game.

16. The apparatus of claim 1, further comprising at least one of an antenna or a transceiver coupled to the at least one processor, wherein the at least one processor is configured to obtain the plurality of layers via at least one of the antenna or the transceiver, and wherein the at least one frame is associated with at least one of: the display processing, image processing, frame processing, or color processing.

17. A method of display processing, comprising:
obtaining a plurality of layers associated with at least one frame, wherein each layer of the plurality of layers includes a set of layer regions, wherein each of the set of layer regions includes a plurality of pixels;
assigning each of the set of layer regions to a corresponding component in a set of components in a display processing unit (DPU) pipeline;
adjusting a portion of the plurality of pixels in at least one layer region of the set of layer regions with the corresponding component in the set of components in the DPU pipeline; and
composing the set of layer regions including the at least one layer region with the adjusted portion of the plurality of pixels.

18. The method of claim 17, wherein assigning each of the set of layer regions to the corresponding component in the set of components comprises:
mapping each of the set of layer regions to the corresponding component in the set of components, such that each of the set of layer regions is assigned to the corresponding component based on the mapping.

19. The method of claim 18, wherein each of the set of layer regions is mapped to the corresponding component in the set of components based on a corresponding processing task associated with each of the set of layer regions.

20. The method of claim 18, wherein each of the set of layer regions is mapped to the corresponding component in the set of components based on a position of each of the set of layer regions or a set of coordinates for each of the set of layer regions.

21. The method of claim 17, wherein the composition of the set of layer regions results in an output of the composition of the set of layer regions, further comprising:
processing the output of the composition of the set of layer regions after the set of layer regions is composed.

22. The method of claim 21, wherein processing the output of the composition of the set of layer regions comprises:
adjusting a pixel value for each of the plurality of pixels in the output of the composition of the set of layer regions.

23. The method of claim 21, further comprising:
transmitting the processed output of the composition of the set of layer regions, wherein the processed output of the composition of the set of layer regions is transmitted to a display or a panel.

24. The method of claim 17, wherein composing the set of layer regions including the at least one layer region with the adjusted portion of the plurality of pixels comprises:
blending at least some of the set of layer regions including the at least one layer region with the adjusted portion of the plurality of pixels.

25. The method of claim 17, wherein the portion of the plurality of pixels in the at least one layer region is adjusted based on processing the plurality of pixels in the at least one layer region, wherein the plurality of pixels in the at least one layer region is processed based on the display processing, image processing, frame processing, or color processing.

26. The method of claim 17, wherein the set of layer regions in each of the plurality of layers corresponds to a set of portions for each of the plurality of layers or a set of regions of interest (ROI) for each of the plurality of layers, and wherein the plurality of pixels in each of the set of layer regions is associated with metadata, a layer hierarchy, a Z-order, or a Z-coordinate.

27. The method of claim 17, wherein each of the set of layer regions includes a corresponding pixel resolution, such that the corresponding pixel resolution of at least one first layer region in the set of layer regions is different from the corresponding pixel resolution of at least one second layer region in the set of layer regions.

28. The method of claim 17, wherein obtaining the plurality of layers comprises: receiving the plurality of layers from at least one of: a graphics processing unit (GPU), a central processing unit (CPU), an application, or a game.

29. The method of claim 17, wherein the at least one frame is associated with at least one of: the display processing, image processing, frame processing, or color processing.

30. A computer-readable medium storing computer executable code for display processing, the code when executed by a processor causes the processor to:
obtain a plurality of layers associated with at least one frame, wherein each layer of the plurality of layers includes a set of layer regions, wherein each of the set of layer regions includes a plurality of pixels;
assign each of the set of layer regions to a corresponding component in a set of components in a display processing unit (DPU) pipeline;
adjust a portion of the plurality of pixels in at least one layer region of the set of layer regions with the corresponding component in the set of components in the DPU pipeline; and
compose the set of layer regions including the at least one layer region with the adjusted portion of the plurality of pixels.
